(19) United States
(12) Patent Application Publication
(10) Pub. No.: US 2025/0134214 A1
(43) Pub. Date: May 1, 2025

(54) BUCKLE ASSEMBLY AND BABY CARRIER

(71) Applicant: WONDERLAND SWITZERLAND AG, Steinhausen (CH)

(72) Inventors: Martijn Hans VAN GELDEREN, Steinhausen (CH); Thomas STOKHOF DE JONG, Steinhausen (CH); Anne BEEFTINK, Steinhausen (CH); Jihua HUANG, Steinhausen (CH); Wuqing LIU, Steinhausen (CH)

(73) Assignee: WONDERLAND SWITZERLAND AG, Steinhausen (CH)

(21) Appl. No.: 18/838,751

(22) PCT Filed: Feb. 16, 2023
(86) PCT No.: PCT/EP2023/053921

§ 371 Date: Aug. 15, 2024

(30) Foreign Application Priority Data
Feb. 16, 2022 (CN) 202210140894.9
Oct. 31, 2022 (CN) 202211346936.0

(51) Int. Cl. A44B 11/04; B62B 9/10; B62B 9/24

(52) U.S. Cl. CPC A44B 11/04; B62B 9/108; B62B 9/24

(57) ABSTRACT

The present disclosure provides a buckle assembly and a baby carrier. The buckle assembly includes a sliding element and a guiding element, wherein the sliding element includes a first fitting part and the guiding element includes a second fitting part, one of the first fitting part and the second fitting part receives the other, so that the sliding element is connected to the guiding element and may slide linearly on the guiding element.

### CROSS-REFERENCE TO RELATED APPLICATIONS

This application is a National Stage application of PCT/EP2023/053921, filed on Feb. 16, 2023, which claims the benefit of Chinese Application No. 202210140894.9, filed on Feb. 16, 2022 and Chinese Application No. 202211346936.0, filed on Oct. 31, 2022, all of which are incorporated herein by reference in their entirety.

### TECHNICAL FIELD

The present disclosure relates to the technical field of buckles, in particular to a buckle assembly with adjustable position and a baby carrier including the buckle assembly.

### BACKGROUND

A baby carrier, such as a baby carriage, is a tool for carrying babies (including infants, toddlers, children, etc.). The baby carriage usually has wheels and a seat. The seat may include a cushion and a backrest. The cushion is used to bear legs and hips of a baby, and the backrest is used to support the back and head of the baby. The wheels can enable the baby carriage to be conveniently pushed. The seat is usually provided with a safety belt to restrain the baby when the baby carriage is pushed, thereby ensuring his/her safety. The safety belt may include a shoulder belt, a waist belt, an abdominal belt, and the like to restrain different parts of the baby's body.

The baby carriage in the prior art may have an adjustable shoulder belt. An upper end of the shoulder belt may be connected to an adjusting buckle which is slidably arranged on an adjusting belt. Both ends of the adjusting belt are connected to the backrest. As the adjusting buckle may slide on the adjusting belt, a position of the upper end of the shoulder belt is adjustable to adapt to babies of different sizes. The backrest of the baby carriage is usually provided with a back cushion, so as to provide a softer touch. The back cushion may be provided with a slit to allow one end of the shoulder belt and the adjusting buckle to pass through.

However, in the prior art, when the shoulder belt passes through the slit, it tends to spread the slit, so that the slit becomes unsightly in appearance, and even the backrest may be partially exposed, resulting in bad touch at the slit. After a small cushion is installed, the shoulder belt is difficult to fit the small cushion, which makes the appearance of the baby carriage messy. Moreover, the shoulder belt of the existing baby carriage is very inconvenient to use, for example, the shoulder belt needs to be removed together with the buckle. This operation is inconvenient, and the height adjustment of the shoulder belt cannot be quickly realized.

### SUMMARY

The present disclosure provides a buckle assembly including a sliding element and a guiding element, wherein the sliding element includes a first fitting part and the guiding element includes a second fitting part, and wherein one of the first fitting part and the second fitting part receives the other, so that the sliding element is connected to the guiding element and may slide linearly on the guiding element.

The present disclosure provides a baby carrier including a frame; a backrest connected to the frame; a back cushion having a slit and at least partially covering the backrest; a belt having an end attached to the frame; and the buckle assembly as described above, wherein the buckle assembly connects the other end of the belt to the backrest. The buckle assembly passes through the slit of the back cushion, and connects the other end of the belt to the backrest to adjust a height of the other end of the belt.

The present disclosure provides a sliding element. The sliding element includes a first fitting part, and the first fitting part further includes a connecting buckle and a neck, wherein the neck connects the connecting buckle to the first fitting part, and a width of the neck is smaller than a width of either of the connecting buckle and the first fitting part.

### BRIEF DESCRIPTION OF THE DRAWINGS

Various objects, features and advantages of the present disclosure will become more apparent by considering the following detailed description of preferred embodiments of the present disclosure in conjunction with the accompanying drawings. The accompanying drawings are only exemplary illustrations of the present disclosure and are not necessarily drawn to scale. In the drawings, the same reference numbers always refer to the same or similar parts. In the drawings:

FIG. 1 is a perspective view of a sliding element of a buckle assembly according to a first embodiment of the present disclosure;

FIG. 2 is a top view of the sliding element of the buckle assembly according to the first embodiment of the present disclosure;

FIG. 3 is another perspective view of the sliding element of the buckle assembly according to the first embodiment of the present disclosure;

FIG. 4 is a side view of the sliding element of the buckle assembly according to the first embodiment of the present disclosure;

FIG. 5 is a front view of the sliding element of the buckle assembly according to the first embodiment of the present disclosure;

FIG. 6 is another side view of the sliding element of the buckle assembly according to the first embodiment of the present disclosure;

FIG. 7 is a rear view of the sliding element of the buckle assembly according to the first embodiment of the present disclosure;

FIG. 8 is a schematic view of a guiding element of the buckle assembly of the first embodiment of the present disclosure;

FIG. 9 is a schematic view of the buckle assembly of the first embodiment of the present disclosure, in which the buckle assembly is arranged on the backrest;

FIG. 10 is a schematic view of a back cushion of a baby carrier of the present disclosure;

FIG. 11 is a schematic view of the buckle assembly according to the first embodiment of the present disclosure, in which the buckle assembly is in a use state;

FIG. 12 is a perspective view of a sliding element of a buckle assembly according to a second embodiment of the present disclosure;

FIG. 13 is a top view of the sliding element of the buckle assembly according to the second embodiment of the present disclosure;

FIG. 14 is a side view of the sliding element of the buckle assembly according to the second embodiment of the present disclosure;

FIG. 15 is a front view of the sliding element of the buckle assembly according to the second embodiment of the present disclosure;

FIG. 16 is a perspective view of a sliding element of a buckle assembly according to a third embodiment of the present disclosure;

FIG. 17 is a top view of the sliding element of the buckle assembly according to the third embodiment of the present disclosure;

FIG. 18 is a side view of the sliding element of the buckle assembly according to the third embodiment of the present disclosure;

FIG. 19 is a front view of the sliding element of the buckle assembly according to the third embodiment of the present disclosure;

FIG. 20 is a rear view of the sliding element of the buckle assembly according to the third embodiment of the present disclosure;

FIG. 21 is a schematic view of a buckle assembly according to a fourth embodiment of the present disclosure;

FIG. 22 is a schematic view of a buckle assembly according to a fifth embodiment of the present disclosure;

FIG. 23 is a schematic view of a buckle assembly according to a sixth embodiment of the present disclosure;

FIG. 24 is an exploded perspective view of the sliding element of the buckle assembly according to the third embodiment of the present disclosure;

FIG. 25 is a schematic perspective view of the sliding element of the buckle assembly according to the third embodiment of the present disclosure;

FIG. 26 is a perspective view of an example of a carrier of the present disclosure;

FIGS. 27A-27D are perspective views of sliding elements of buckle assemblies according to seventh to ninth embodiments of the present disclosure, in which the sliding elements are respectively arranged on the guiding elements;

FIGS. 28A-28D are schematic side views of sliding elements of buckle assemblies according to seventh to ninth embodiments of the present disclosure, in which the sliding elements are respectively arranged on the guiding elements;

FIG. 29 is a perspective view of the sliding element of the buckle assembly according to a seventh embodiment of the present disclosure;

FIG. 30 is a plan view of a buckle assembly according to the seventh embodiment of the present disclosure;

FIG. 31 is another perspective view of the sliding element of the buckle assembly according to the seventh embodiment of the present disclosure;

FIG. 32 is a side view of the sliding element of the buckle assembly according to the seventh embodiment of the present disclosure;

FIG. 33 is a perspective view of the sliding element of the buckle assembly according to the eighth embodiment of the present disclosure;

FIG. 34 is a side view of the sliding element of the buckle assembly according to the eighth embodiment of the present disclosure;

FIG. 35 is a top view of the sliding element of the buckle assembly according to the eighth embodiment of the present disclosure;

FIG. 36 is a perspective view of the sliding element of the buckle assembly according to the ninth embodiment of the present disclosure;

FIG. 37 is a side view of the sliding element of the buckle assembly according to the ninth embodiment of the present disclosure;

FIG. 38 is a perspective view of a sliding element of a buckle assembly according to a tenth embodiment of the present disclosure;

FIG. 39 is a top perspective view of a sliding element of a buckle assembly according to an eleventh embodiment of the present disclosure;

FIG. 40 is a plan view of a zipper puller of the buckle assembly according to the eleventh embodiment of the present disclosure;

FIG. 41 is a plan view of the sliding element of the buckle assembly of the eleventh embodiment of the present disclosure, in which a lower buckle is removed;

FIG. 42 is another top perspective view of the sliding element of the buckle assembly according to the eleventh embodiment of the present disclosure;

FIG. 43 is a bottom perspective view of the sliding element of the buckle assembly according to the eleventh embodiment of the present disclosure;

FIG. 44 is an exploded perspective view of the sliding element of the buckle assembly according to the eleventh embodiment of the present disclosure;

FIG. 45 is a perspective view of a lower buckle of the buckle assembly of the eleventh embodiment of the present disclosure; and

FIG. 46 is another bottom perspective view of the sliding element of the buckle assembly of the eleventh embodiment of the present disclosure, in which the lower buckle is removed.

### LIST OF REFERENCE NUMBERS

Baby Carriage 1
Frame 101
Wheel 102
Backrest Frame 103
Sliding Element 10
Connecting Buckle 110
Through Hole 111
Locking Part 112
Pivot Hole 113
Operating Part 114
Neck 120
Pivot Shaft 121
First Fitting Part 130
Opening 131
Finger Part 132
Boss 1321
Upper Buckle 133
Lower Buckle 134
Zipper Puller 135
Guiding element 20
Second Fitting Part 210
Recess 211
Wing 220
Connecting Part 230
Belt 30
Adjusting Buckle 40
Backrest 80
Back cushion 90
Slit 910

### DETAILED DESCRIPTION

In order to explain the entire concept of the present disclosure, the following detailed description will be made by way of example with reference to the accompanying drawings.

It should be noted that in the following description, many specific details are set forth in order to fully understand the present disclosure. However, the present disclosure can be implemented in other ways different from those described herein. Therefore, the protection scope of the present disclosure is not limited by the specific embodiments as disclosed below.

In addition, in the description of the present disclosure, it should be understood that the terms “center”, “upper”, “lower”, “front”, “rear”, “left”, “right”, “vertical”, “horizontal”, “top”, “bottom”, “inner”, “outer”, “axial”, “radial”, “circumferential” and other indicated orientations or positional relationships are based on orientations or positional relationships shown in the drawings, which are only intended to facilitate for describing the present disclosure and simplifying the description, but does not indicate or imply that the referred device or component must have a specific orientation, be constructed and operated in a specific orientation, and thus should not be construed as limiting the present disclosure.

In the present disclosure, unless otherwise specified and limited, the terms “install”, “interconnect”, “connect” and “fix” should be understood broadly, for example, which can refer to “fixedly connect”, “detachably connect” or “integrate”; and can refer to “directly connect” or “indirectly connect through an intermediate medium”, and can also refer to “internally communicate between two components” or “interact between two components”. However, indicating “directly connect” means that two connected subjects do not build a connection relationship through a transitional structure, but are only connected by a connecting structure to form an integrated structure. For those of ordinary skill in the art, the specific meanings of the above terms in the present disclosure can be understood according to specific situations.

In the present disclosure, unless otherwise specified and limited, the first feature “on” or “under” the second feature may refer to the first feature directly contacting with the second feature, or the first feature indirectly contacting with the second feature through an intermediate medium. In the description of this specification, the description referring to the terms “one embodiment”, “some embodiments”, “an example”, “a specific example” or “some examples” means that the specific features, structures, materials or characteristics described in connection with this embodiment or example are included in at least one embodiment or example of the present disclosure. In this specification, the schematic expressions of the above terms do not necessarily refer to the same embodiment or example. Furthermore, the specific features, structures, materials or characteristics described may be combined in any one or more embodiments or examples in a suitable manner.

The present disclosure provides a buckle assembly and a baby carrier including the buckle assembly. The baby carrier may be used by babies or children. The baby carrier may be, for example, a baby carriage, a safety seat, a dining chair, a high chair, and the like. Optionally, the baby carrier may be folded to facilitate storage. The baby carrier may include a backrest 80 for supporting the back of an occupant; a back cushion 90 having a slit 910 and at least partially covering the backrest 80; a belt 30 for restraining the shoulders of the occupant; and a buckle assembly. The buckle assembly may pass through the slit of the back cushion 90 and connect one end of the belt 30 to the backrest 80 to adjust a height of one end of the belt 30. The baby carrier may include two buckle assemblies and two belts symmetrically located on the backrest 80.

A first embodiment of the present disclosure will be described below.

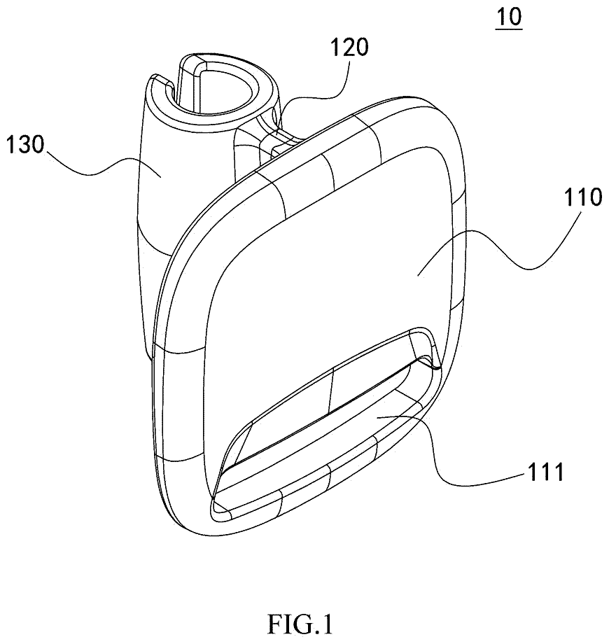

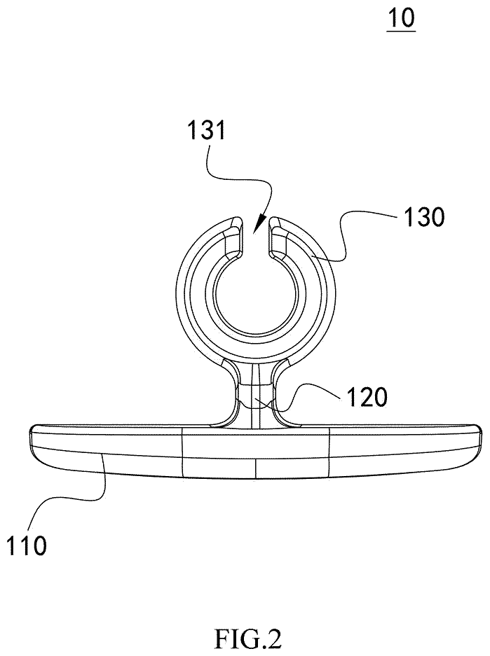

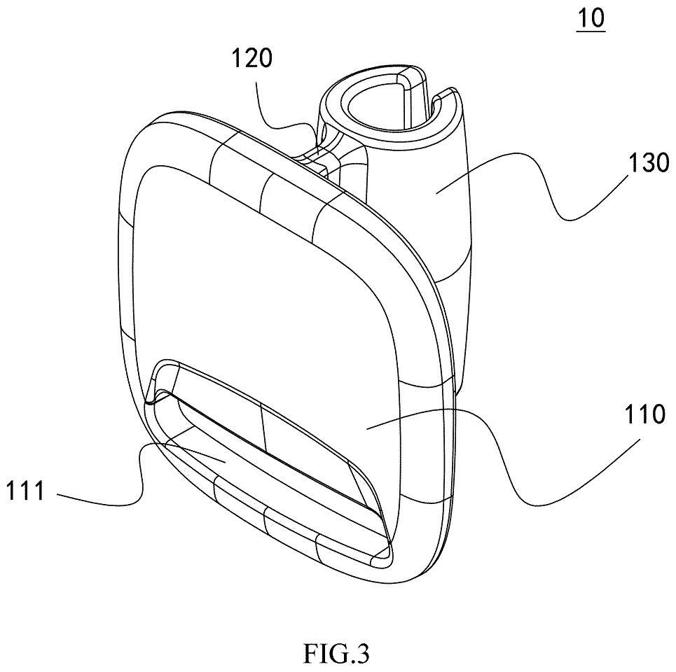

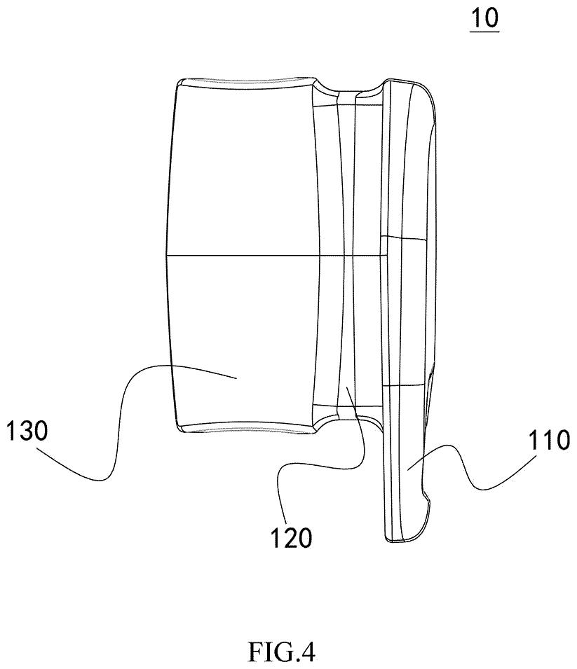

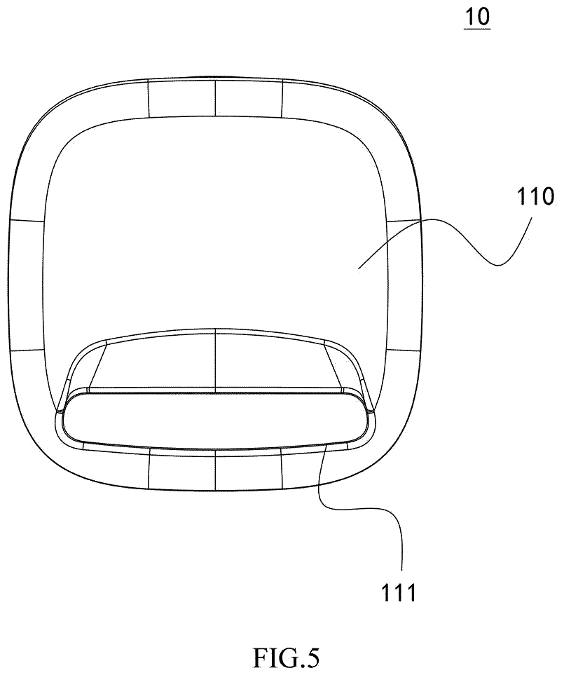

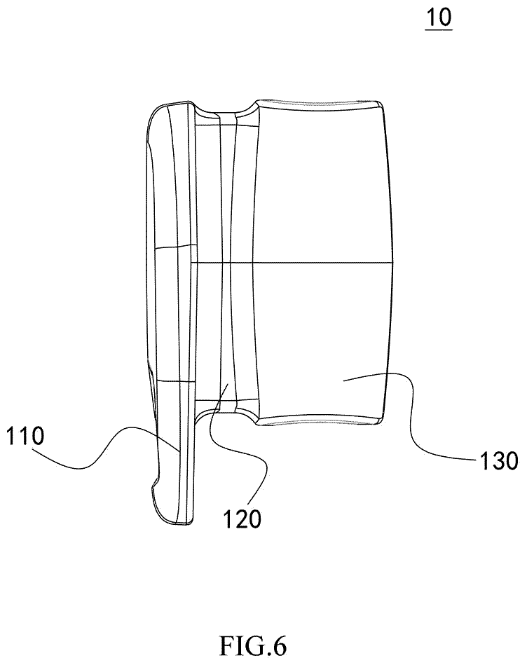

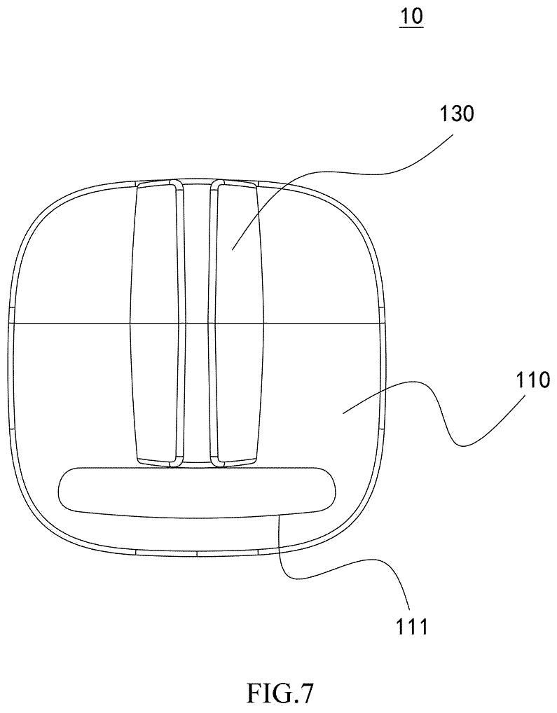

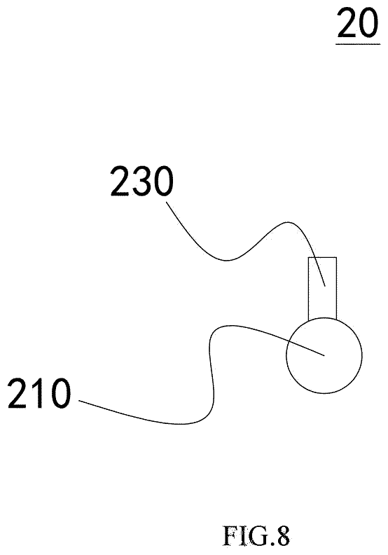

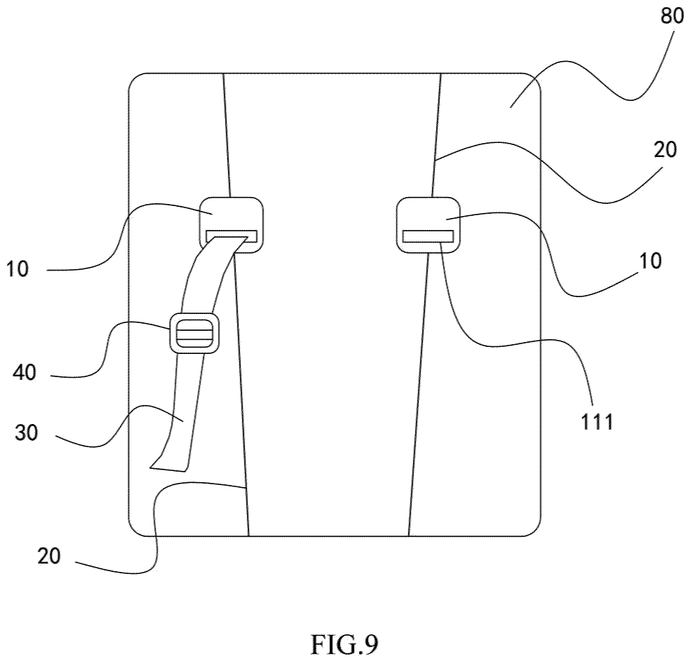

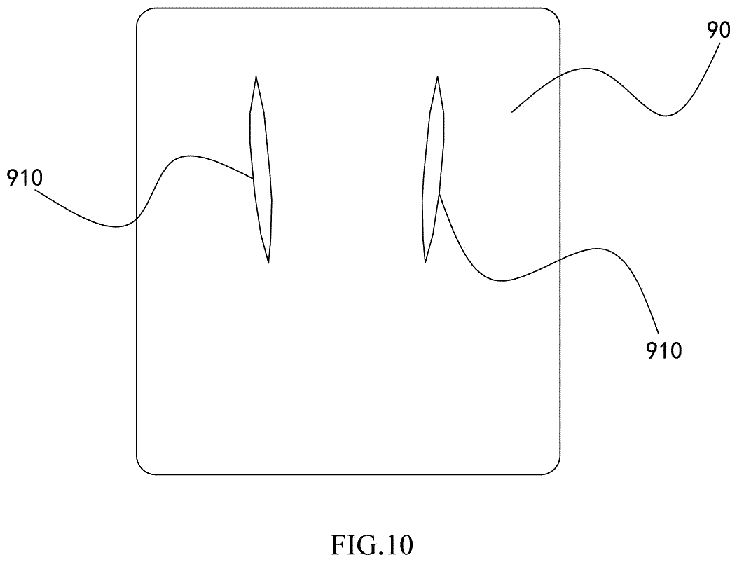

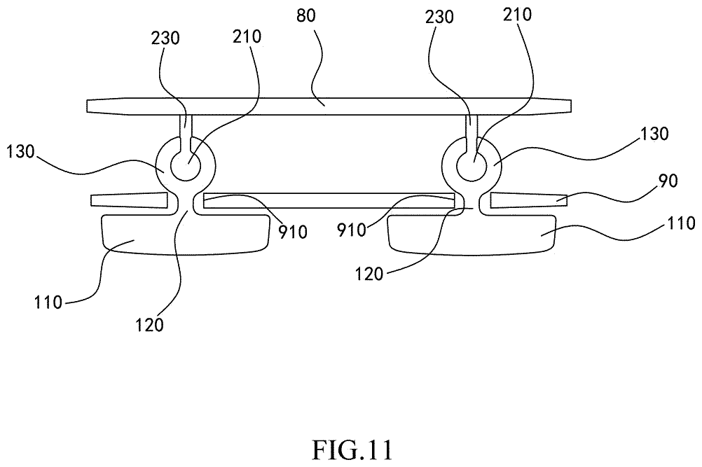

FIG. 1 is a perspective view of a sliding element of a buckle assembly according to the first embodiment of the present disclosure; FIG. 2 is a top view of the sliding element of the buckle assembly according to the first embodiment of the present disclosure; FIG. 3 is another perspective view of the sliding element of the buckle assembly according to the first embodiment of the present disclosure; FIG. 4 is a side view of the sliding element of the buckle assembly according to the first embodiment of the present disclosure; FIG. 5 is a front view of the sliding element of the buckle assembly according to the first embodiment of the present disclosure; FIG. 6 is another side view of the sliding element of the buckle assembly according to the first embodiment of the present disclosure; FIG. 7 is a rear view of the sliding element of the buckle assembly according to the first embodiment of the present disclosure; FIG. 8 is a schematic view of the guiding element of the buckle assembly according to the first embodiment of the present disclosure; FIG. 9 is a schematic view of the buckle assembly of the first embodiment of the present disclosure, in which the buckle assembly is arranged on the backrest; FIG. 10 is a schematic view of the back cushion of the baby carrier of the present disclosure; and FIG. 11 is a schematic view of the buckle assembly according to the first embodiment of the present disclosure, in which the buckle assembly is in a use state.

Referring to FIGS. 1 and 9-11, the buckle assembly may include a sliding element 10 and a guiding element 20. The sliding element 10 may include a first fitting part 130. The guiding element 20 may include a second fitting part 210. One of the first fitting part 130 and the second fitting part 210 may be formed as a tubular element, while the other of the first fitting part 130 and the second fitting part 210 may be formed as an annular element. In the first embodiment, the first fitting part 130 may be formed as an annular element, while the second fitting part 210 may be formed as a tubular element. As shown in FIG. 2, the first fitting part 130 formed as an annular element may have a substantially C-shaped cross-section and may be formed with an opening 131. The annular element may have a large width so that it is formed in a shape of a sleeve. The annular element may also have a smaller width, so that it is formed into a C-shaped ring. The tubular element may have a generally cylindrical shape, and may be solid or hollow. An inner shape of the first fitting part 130 formed as an annular element may correspond to an outer shape of the second fitting part 210 formed as a tubular element, thereby forming a snap fit. That is, the second fitting part 210 may be accommodated in the first fitting part 130 to form connection between the sliding element 10 and the guiding element 20. Optionally, the tubular element may be formed with an outer contour of other shapes, such as a regular hexagon, so that the first fitting part 130 can be prevented from pivoting with respect to the second fitting part 210 to some extent.

Referring to FIGS. 1 and 8, the first fitting part 130 formed as an annular element may receive the second fitting part 210 formed as a tubular element, so that the sliding element 10 is connected to the guiding element 20 and the sliding element 10 may slide linearly on the guiding element 20.

Referring to FIGS. 1-7, the sliding element 10 may further include a connecting buckle 110 and a neck 120. The neck 120 may connect the connecting buckle 110 with the first fitting part 130. The sliding element 10 may be integrally formed. A width of the neck 120 may be smaller than a width of any one of the connecting buckle 110 and the first fitting part 130. The above width may refer to a dimension in a left-right direction as shown in FIG. 2.

Referring to FIG. 8, the guiding element 20 may further include a connecting part 230. A width of the connecting part 230 may be smaller than a width of the second fitting part 210. The above width may refer to a dimension in the left-right direction as shown in FIG. 8.

Referring to FIG. 9, the baby carrier of the present disclosure may include a backrest 80. The backrest 80 shown in FIG. 9 is rectangular, but the present disclosure is not limited thereto. The guiding element 20 may be formed in an elongated shape. Two guiding elements 20 may be symmetrically provided to the backrest 80 (for example, by sewing, adhering, etc.). The guiding element 20 may be arranged substantially vertically or slightly obliquely. The connecting buckle 110 of the sliding element 10 may be slidably connected to the belt 30. The belt 30 may be a shoulder belt of the baby carrier for restraining a shoulder of an occupant, thereby protecting the safety of the occupant. The belt 30 may be a woven belt. The buckle assembly may further include an adjusting buckle 40. The connecting buckle 110 may include a through hole 111. One end of the belt 30 may pass through the adjusting buckle 40, then through the through hole 111, and finally through the adjusting buckle 40 again. The adjusting buckle 40 may exert a certain clamping force on the belt 30 passing therethrough, thereby maintaining a distance of the belt 30 located between the adjusting buckle 40 and the guiding element 20. In other words, the adjusting buckle 40 may be used to adjust a position of the belt 30 passing through the through hole, and therefore, the adjusting buckle 40 may be used to adjust the tightness of the belt 30 with respect to a baby carried on the baby carrier. The adjusting buckle 40 may be, for example, a common “ [symbol] ”-shaped (two-hole shaped) or “ [symbol] ”-shaped (three-hole shaped) buckle. The other end of the belt 30 may be connected to a frame or cushion of the baby carrier. In this way, one end of the belt 30 may move on the backrest 80 through the buckle assembly, while the other end of the belt 30 is fixedly connected to the baby carrier, so that the belt 30 can be adapted to babies or children with different shoulder heights.

Although only one adjusting buckle 40 and one belt 30 are shown in FIG. 9, it is only intended to better show the sliding element 10. In actual use, the sliding element 10 at a right side is also connected to a belt 30 and an adjusting buckle 40.

Referring to FIG. 10, the baby carrier includes a back cushion 90 provided at a side of the backrest 80. The back cushion 90 shown in FIG. 10 is rectangular, but the present disclosure is not limited thereto. The back cushion 90 may have a size that completely covers the backrest 80 and may have a shape corresponding to the backrest 80. The back cushion 90 may be located between the back of the occupant and the backrest 80. The back cushion 90 may be flexible to provide a comfortable feeling. A slit 910 may be formed on the back cushion 90. The number of slits 910 may correspond to the number of buckle assemblies, for example, two, but the present disclosure is not limited thereto. In this embodiment, two slits 910 are symmetrically arranged on the backrest 90. The slit 910 may be elongated and may extend in a direction substantially consistent with the guiding element 20. A length of the slit 91 may be equal to or less than a length of the guiding element 20. The slit 910 shown in FIG. 10 may have a certain width, and alternatively, parts of the slit 910 on both sides may overlap with each other, so that objects behind the slit 910 cannot be seen visually, thereby improving the aesthetics of the baby carrier.

Referring to FIG. 11, the neck 120 of the sliding element 10 may pass through the slit 910, so that the connecting buckle 110 is located below the backrest 90 (according to a perspective shown in FIG. 11), and the first fitting part 130 is located above the backrest 90 (according to a perspective shown in FIG. 11). Since the neck 120 is thinner than the connecting buckle 110 and the first fitting part 130, the slit 910 will not be greatly deformed due to the neck 120 penetrating therethrough. In this way, the appearance of the back cushion 90 at the slit 910 can be kept beautiful. The connecting buckle 110 may be formed as a rectangular sheet. The connecting buckle 110 may cover a position where the neck 120 passes through the slit 910. Therefore, even if the slit 910 is slightly deformed by the neck 120 penetrating therethrough, the deformed part will be covered by the connecting buckle 110 without affecting the appearance of the baby carrier. A thickness of the connecting buckle 110 may be formed to facilitate grasping and moving by fingers.

Referring to FIG. 11, an opening 131 may be formed at a side of the first fitting part 130 away from the neck 120. A size of the opening 131 may correspond to a size of the connecting part 230. An inner space of the first fitting part 130 may match with an outer contour of the second fitting part 210. In this way, the sliding element 10 may smoothly slide on the guiding element 20. The size of the opening 131 is less than that of the second fitting part 210, so that the first fitting part 130 and the second fitting part 210 will not be disengaged from each other.

A second embodiment of the present disclosure will be described below.

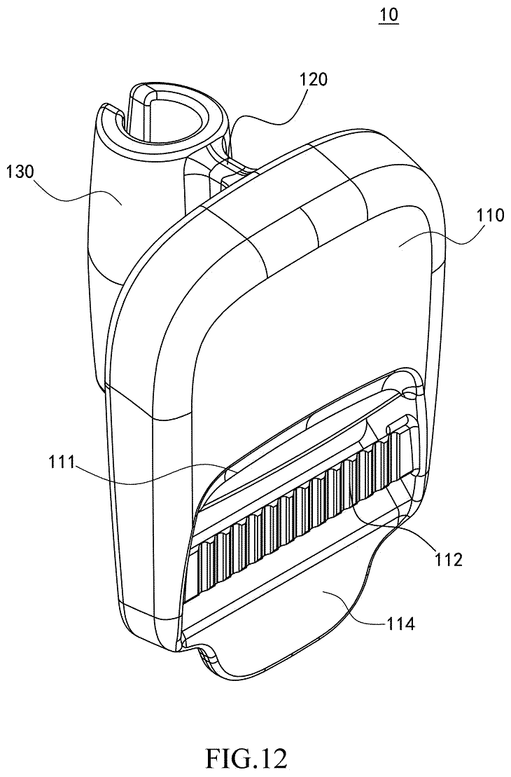

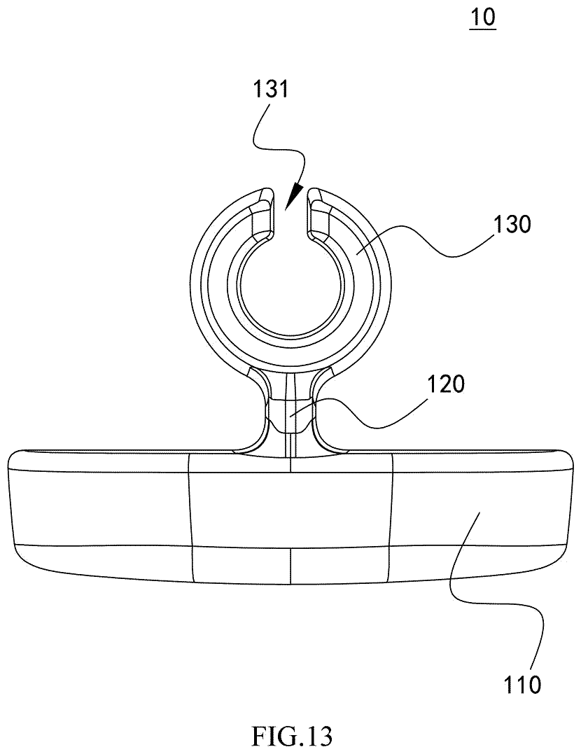

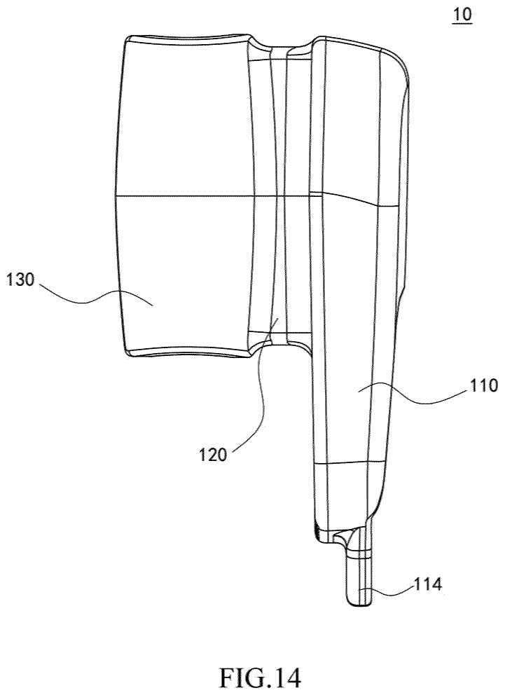

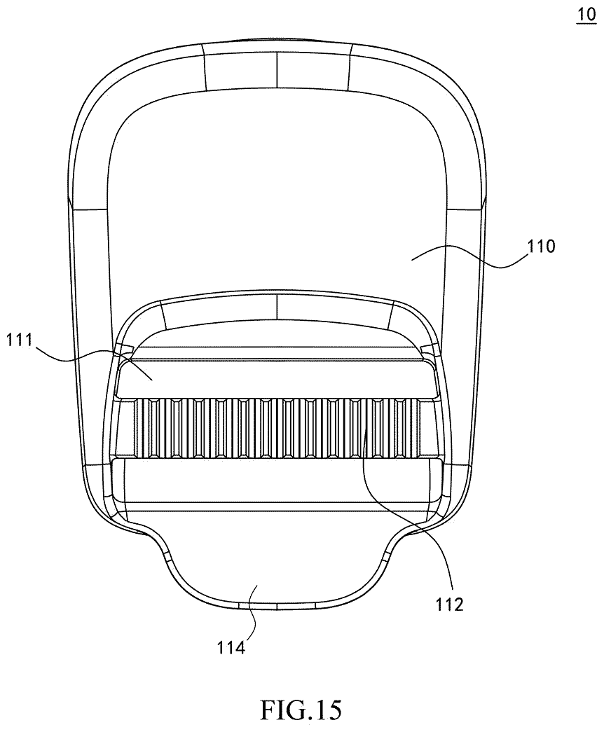

FIG. 12 is a perspective view of a sliding element of a buckle assembly according to a second embodiment of the present disclosure, FIG. 13 is a top view of the sliding element of the buckle assembly according to the second embodiment of the present disclosure, FIG. 14 is a side view of the sliding element of the buckle assembly according to the second embodiment of the present disclosure, and FIG. 15 is a front view of the sliding element of the buckle assembly according to the second embodiment of the present disclosure.

Referring to FIGS. 12-15, the second embodiment of the present disclosure is mainly different from the first embodiment in that, the connecting buckle 110 further includes a locking part 112. The locking part 112 may be a rod provided in the through hole 111. The belt 30 passes through the through hole 111 in a first direction from one side of the locking part 112, and passes through the through hole 111 again in a second direction opposite to the first direction from the other side of the locking part 112. In other words, with the locking part 112, the connecting buckle 110 may simultaneously have a function of the adjusting buckle 40. In this way, the buckle assembly of the second embodiment of the present disclosure may not include the adjusting buckle 40.

The locking part 112 may be alternately formed with a plurality of protrusions and a plurality of depressions. In other words, the locking part 112 may be formed in an uneven shape to increase a friction force. It can be understood that other ways can also be used to increase the friction force, such as bumps and stripes, or other materials with higher friction force (for example, rubber) can be used to form the locking portion 112.

The connecting buckle 110 further includes an operating part 114. The operation part 114 may be formed as a lug protruding from one side (for example, a lower side in FIGS. 12, 15 and 24) of the connection buckle 110. The operating part 114 may be grasped by the user's fingers to move the sliding element conveniently.

A third embodiment of the present disclosure will be described below.

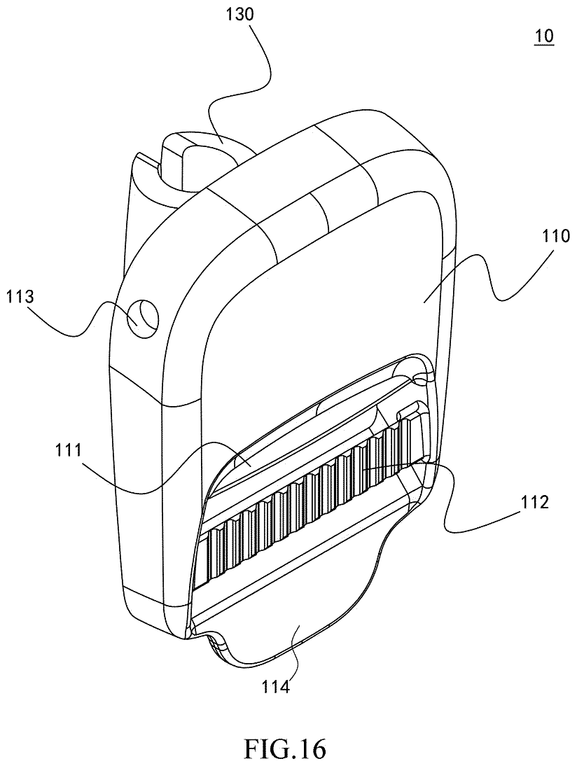

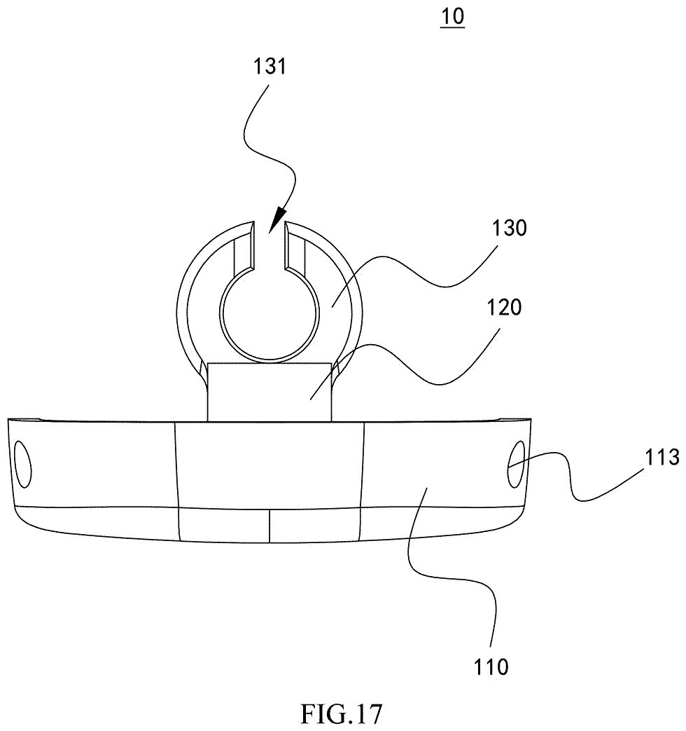

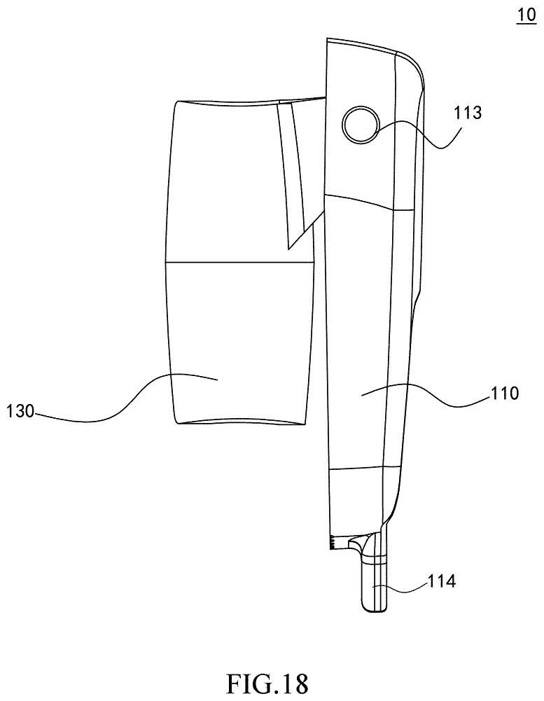

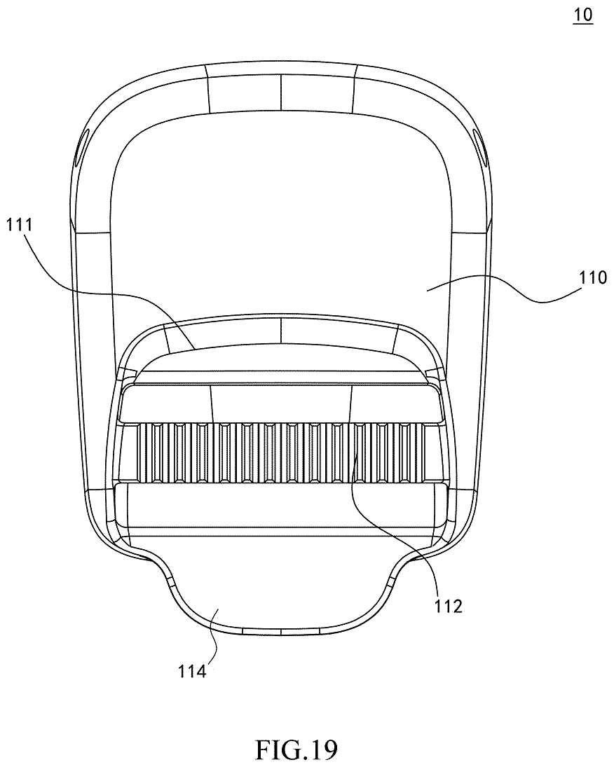

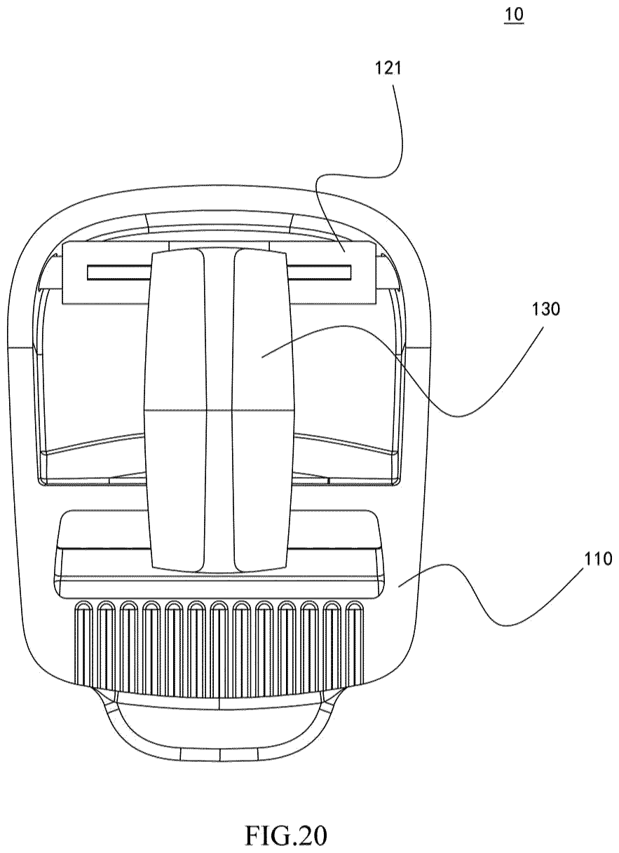

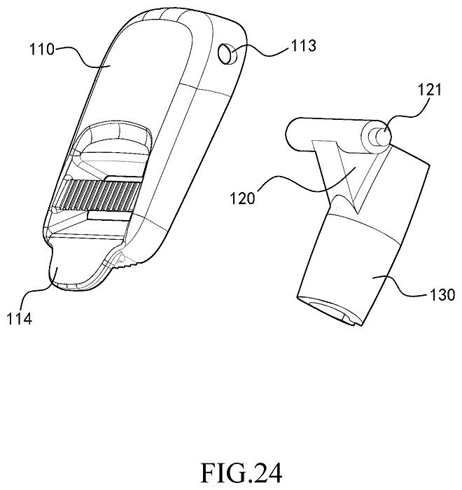

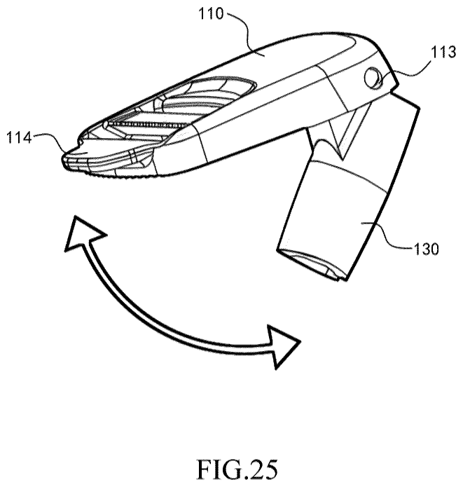

FIG. 16 is a perspective view of a sliding element of a buckle assembly according to a third embodiment of the present disclosure, FIG. 17 is a top view of the sliding element of the buckle assembly according to the third embodiment of the present disclosure, FIG. 18 is a side view of the sliding element of the buckle assembly according to the third embodiment of the present disclosure, FIG. 19 is a front view of the sliding element of the buckle assembly according to the third embodiment of the present disclosure, FIG. 20 is a rear view of the sliding element of the buckle assembly according to the third embodiment of the present disclosure, FIG. 24 is an exploded perspective view of the sliding element of the buckle assembly according to the third embodiment of the present disclosure, and FIG. 25 is a schematic perspective view of the sliding element of the buckle assembly according to the third embodiment of the present disclosure.

Referring to FIGS. 16-20 and 24-25, the third embodiment of the present disclosure is different from the second embodiment in that, a pivot shaft 121 may be formed on the neck 120 of the sliding element 10. A pivot hole 113 may be formed on the connecting buckle 110. The pivot shaft 121 may be positioned in the pivot hole 113 so that the connecting buckle 110 may pivot with respect to the neck 120. Since the connecting buckle 110 may pivot with respect to the neck 120, it can be operated more conveniently, for example, the connecting buckle 110 may be rotated to an appropriate angle (as shown in FIG. 25), and the operator may pinch/hold a lower part of the connecting buckle 110 with his thumb and forefinger to move the sliding element 10 or adjust the belt 30 more conveniently. Furthermore, since the connecting buckle 110 may pivot with respect to the neck 120, the connecting buckle 110 can better adapt to the movement of the belt 30. As shown in FIG. 25, the connecting buckle 110 may pivot in an arrow direction with respect to the neck 120.

A fourth embodiment of the present disclosure will be described below.

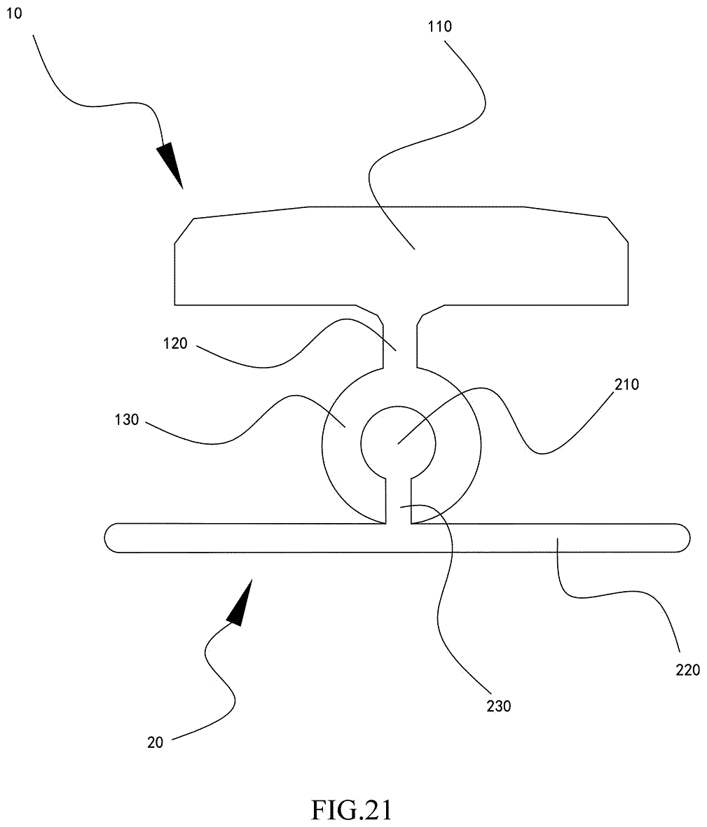

FIG. 21 is a schematic view of a buckle assembly according to a fourth embodiment of the present disclosure.

Referring to FIG. 21, the fourth embodiment of the present disclosure is different from the first embodiment in that, the guiding element 20 may further include a wing 220. The wing 220 may be formed on a side of the connecting part 230 opposite to the second fitting part 210, and the wing 220 may be formed as a sheet perpendicular to the connecting part 230. That is, as shown in FIG. 21, the wing 220 is formed as a horizontal sheet. The connecting part 230 extends upward perpendicular to the wing 220. The second fitting part 210 is located at an upper end of the connecting part 230. The wing 220 may be formed as a square, a rectangle or a circle, for example, but the shape of the wing 220 is not limited in the present disclosure. The wing 220 may keep the second fitting part 210 in an upright state more stably, so that the second fitting part 210 is not easily moved by an external force to skew and contact with the backrest 80, thereby prevent from affecting the connection between the second fitting part 210 and the first fitting part 130.

A fifth embodiment of the present disclosure will be described below.

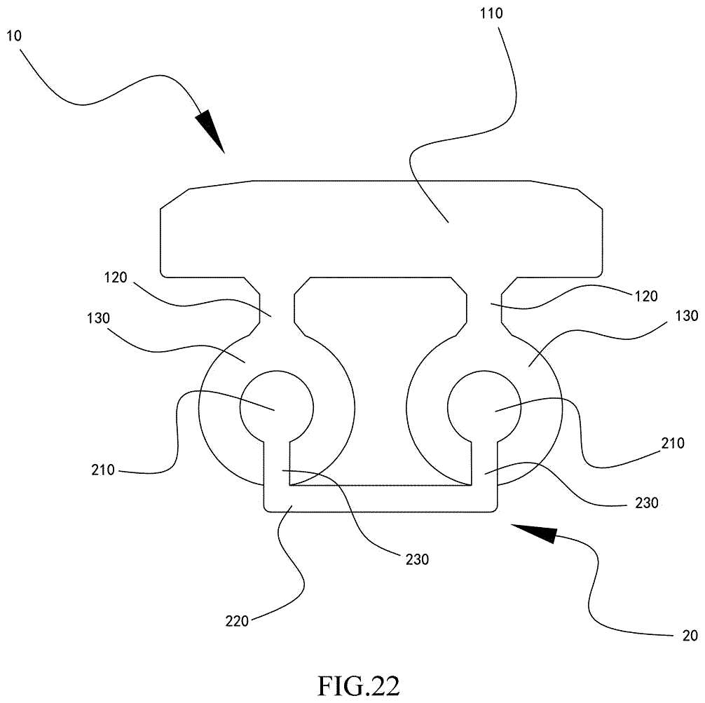

FIG. 22 is a schematic view of a buckle assembly according to a fifth embodiment of the present disclosure.

Referring to FIG. 22, the fifth embodiment of the present disclosure is different from the fourth embodiment in that, the sliding element 10 may include two first fitting parts 130 and two necks 120, and the guiding element 20 may include two second fitting parts 210 and two connecting parts 230. The two first fitting parts 130 may be connected to the two second fitting parts 210, respectively. The wing 220 may connect two connecting parts 230. In this embodiment, since there are more connecting positions between the sliding element 10 and the guiding element 20 than in other embodiments, the connection between the sliding element 10 and the guiding element 20 is more stable. Optionally, the sliding element 10 may include more than two first fitting parts 130 and more than two necks 120, and the guiding element 20 may include more than two second fitting parts 210 and more than two connecting parts 230.

A sixth embodiment of the present disclosure will be described below.

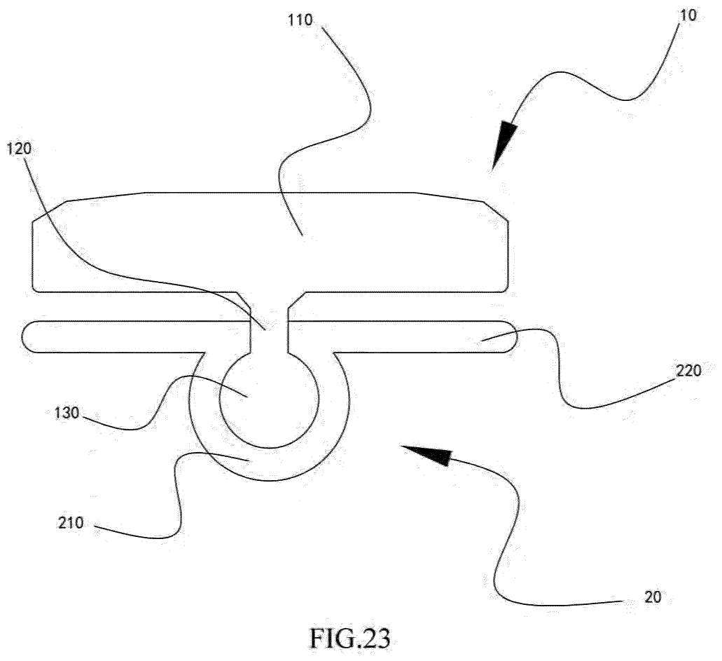

FIG. 23 is a schematic view of a buckle assembly according to a sixth embodiment of the present disclosure.

Referring to FIG. 23, the sixth embodiment of the present disclosure is different from the fourth embodiment in that, the first fitting part 130 may be formed as a tubular element, while the second fitting part 210 may be formed as an annular element. The second fitting part 210 formed as an annular element may be formed with an opening at the upper side, and the wing 220 extends horizontally from both sides of the opening to left and right sides thereof. That is, the guiding element 20 may have only the second fitting part 210 and the wing 220, and may not have the connecting part 230. The first fitting part 130 formed as a tubular element is formed at a lower end of the neck 120. The first fitting part 130 is received by the second fitting part 210, thereby forming the connection between the sliding element 10 and the guiding element 20. The buckle assembly of this embodiment may have a smaller thickness. With the wing 220, the buckle assembly of this embodiment still has good stability.

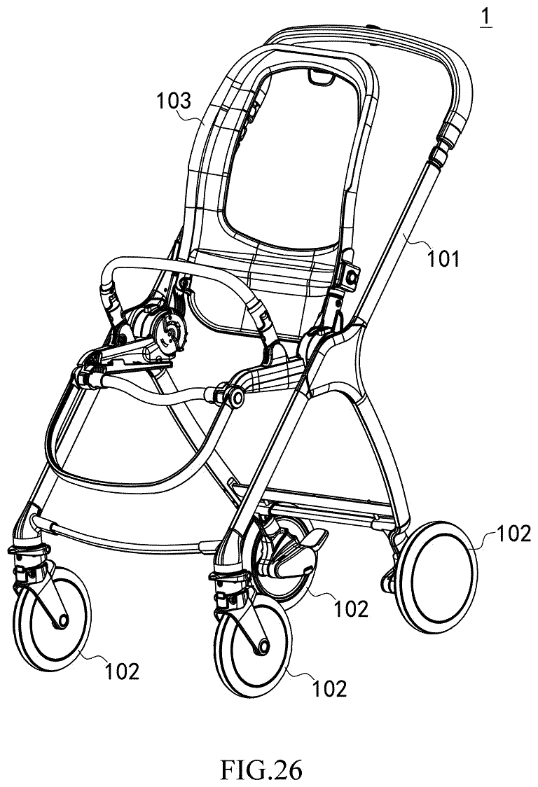

FIG. 26 is a perspective view of an example of a carrier of the present disclosure. The carrier 1 may be a baby carriage, and may include a frame 101; a plurality of wheels 102 located below the frame 101, so that the carrier 1 may be pushed; a backrest frame 103 pivotally connected to the frame 101. The carrier 1 may further include a backrest 80 (see FIG. 9) and a belt 30 (see FIG. 9). The backrest 80 may be attached to the backrest frame 103.

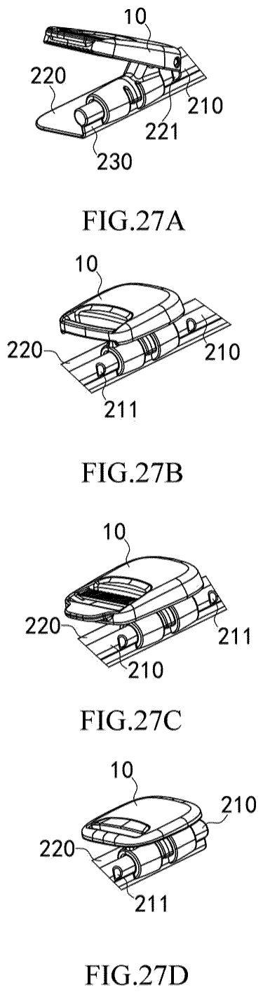

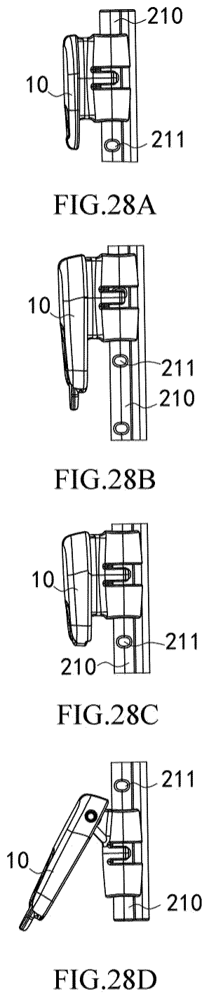

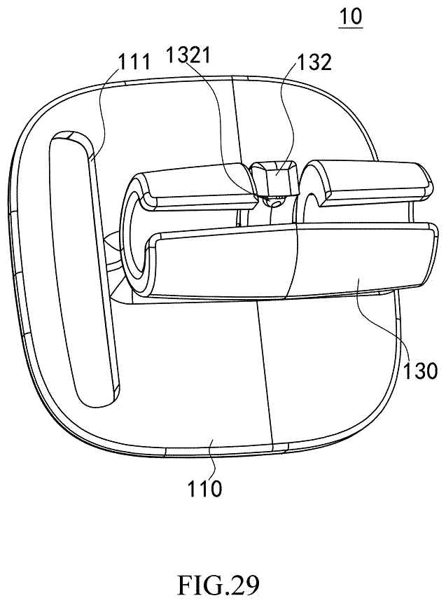

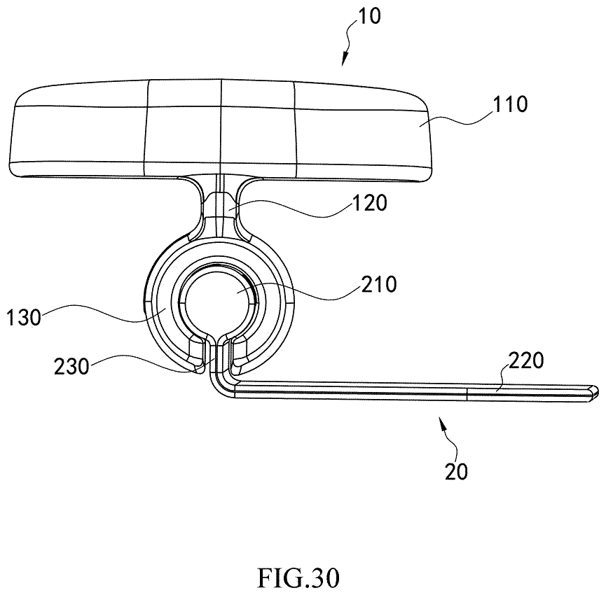

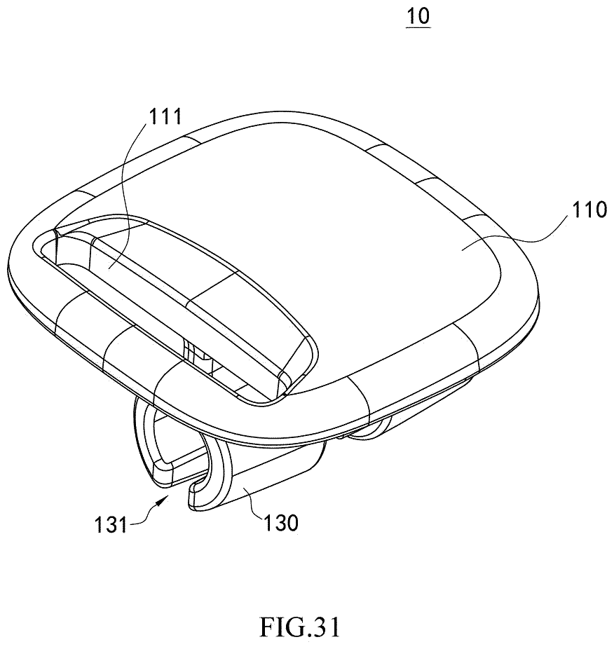

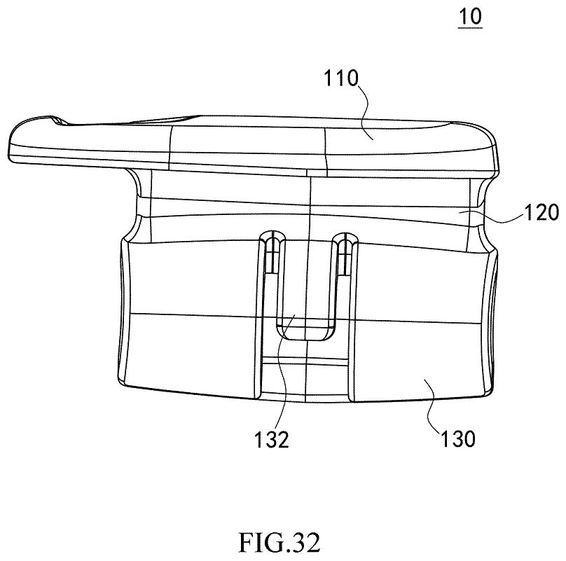

FIGS. 27A-27D are perspective views of sliding elements of buckle assemblies according to seventh to ninth embodiments of the present disclosure, in which the sliding elements are respectively arranged on the guiding elements; FIGS. 28A-28D are schematic side views of sliding elements of buckle assemblies according to seventh to ninth embodiments of the present disclosure, in which the sliding elements are respectively arranged on the guiding elements; FIG. 29 is a perspective view of the sliding element of the buckle assembly according to the seventh embodiment of the present disclosure; FIG. 30 is a plan view of the buckle assembly according to the seventh embodiment of the present disclosure; FIG. 31 is another perspective view of the sliding element of the buckle assembly according to the seventh embodiment of the present disclosure; and FIG. 32 is a side view of the sliding element of the buckle assembly according to the seventh embodiment of the present disclosure.

The seventh to ninth embodiments of the present disclosure will be described below.

FIGS. 27A to 32 are the seventh embodiment of the present disclosure. The difference between the seventh embodiment and the first embodiment will be described below.

As shown in FIGS. 27A and 28D, the second fitting part 210 may be formed with a plurality of recesses 211 along its length direction. The plurality of recesses 211 may be provided at a side part of the second fitting part 210. The plurality of recesses 211 may be provided on the second fitting part 210 at the same intervals. Optionally, the plurality of recesses 211 may be provided on the second fitting part 210 at different intervals.

As shown in FIG. 30, the second fitting part 210 may be formed at the upper side of the connecting part 230, and the wing 220 may be formed at the lower side of the connecting part 230. The wing 220 may be formed as a sheet perpendicular to the connecting part 230. As shown in FIG. 30, the wing 220 is formed in a horizontal sheet or flat plate shape. The connecting part 230 extends upward perpendicular to the wing 220. The second fitting part 210 is located at the upper end of the connecting part 230. The wing 220 may be rigid and fixed to the backrest 80, so that the second fitting part 210 is kept in an upright state more stably, so that the second fitting part 210 is not easily moved by an external force to skew and contact with the backrest 80, thereby preventing from affecting the connection between the second fitting part 210 and the first fitting part 130. As shown in FIG. 30, in the seventh embodiment, the wing 220 extends horizontally to the right from the lower end of the connecting part 230. Optionally, the wing 220 extends horizontally from the lower end of the connecting part 230 to the left and right at the same time.

As shown in FIGS. 29 and 32, a finger part 132 may be formed on the first fitting part 130. The finger part 132 may be centrally positioned in a length direction of the first fitting part 130. The finger part 132 may be located at a side part of the first fitting part 130.

As shown in FIGS. 28A-28D, 29 and 30, the finger part 132 extends from the neck part 120 and is disengaged from other parts of the first fitting part 130, so as to have a free terminal end. Therefore, the finger part 132 has elasticity in directions close to and away from the second fitting part 210.

As shown in FIGS. 28A-28D and 29, an inner side of the finger part 132 may be formed with a boss 1321 protruding inward. When the sliding element 10 slides on the guiding element 20, the finger part 132 of the sliding element 10 may be engaged with one of the plurality of recesses 211. Specifically, the boss 1321 of the finger part 132 may form with the recess 211 in interference fit to provide additional resistance to the sliding of the sliding element 10 on the guiding element 20. Here, a preferable interference amount of interference fit is 0.7 mm, but the present disclosure is not limited thereto. The interference amount may be provided to make the clamping position tighter. When a force applied to the sliding element 10 along the second fitting part 210 exceeds a threshold value, the finger part 132 will be elastically deformed, so that the boss 1321 is disengaged from the recess 211.

Optionally, the finger part 132 is pivotally connected to the neck 120. The first fitting part 130 may include an actuating part (not shown). The actuating part may be operated to pivot the finger part 132 away from the second fitting part 210, so that the boss 1321 of the finger part 132 may be actively disengaged from the recess 211.

In the seventh embodiment, a fixing force between the sliding element 10 and the guiding element 20 can be increased by the engagement of the finger part 132 with the recess 211. The plurality of recesses 211 on the second fitting part 210 can enable the operator feel a distance that the sliding element 10 moves. The actuating part may make the finger part 132 more convenient to disengage from the recess 211.

In the seventh embodiment, a single adjusting buckle 40 (see FIG. 9) is required to adjust the length of the belt 30.

The buckle assembly of this embodiment is simple in appearance and convenient to operate.

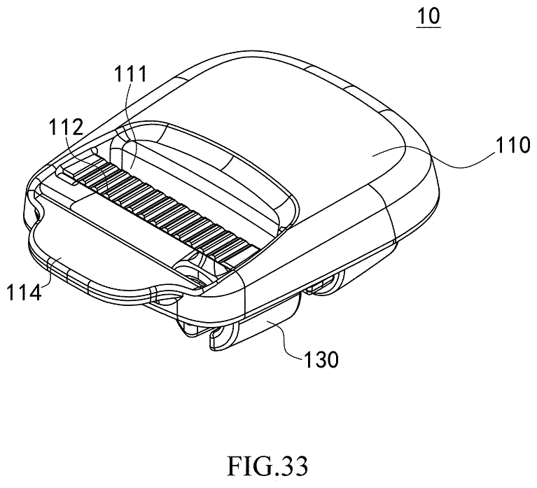

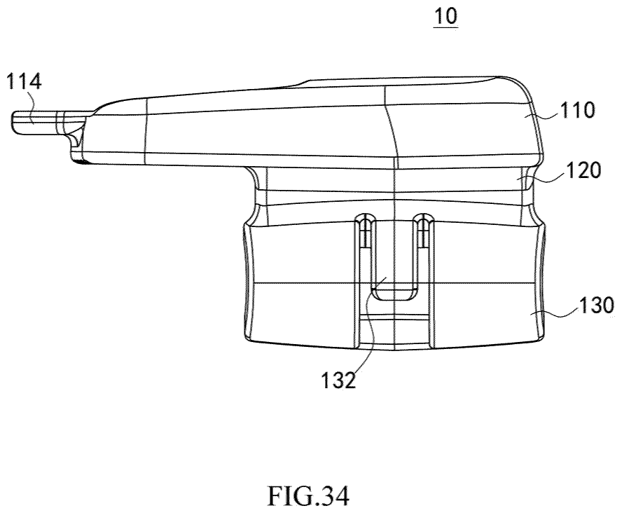

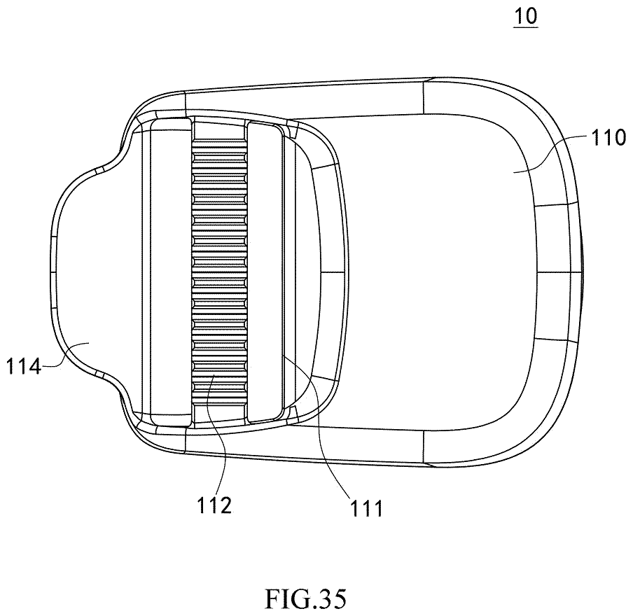

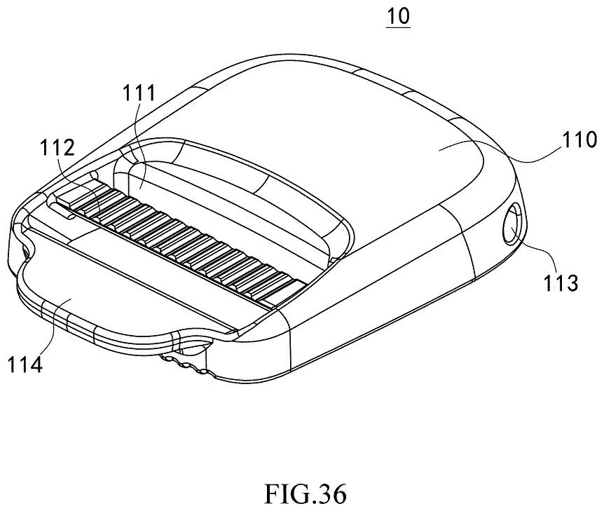

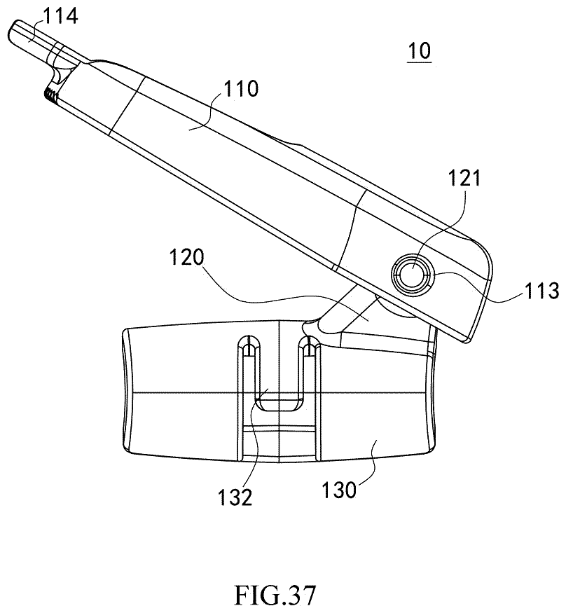

FIG. 33 is a perspective view of the sliding element of the buckle assembly according to an eighth embodiment of the present disclosure, FIG. 34 is a side view of the sliding element of the buckle assembly according to the eighth embodiment of the present disclosure, FIG. 35 is a top view of the sliding element of the buckle assembly according to the eighth embodiment of the present disclosure, FIG. 36 is a perspective view of the sliding element of the buckle assembly according to a ninth embodiment of the present disclosure, and FIG. 37 is a side view of the sliding element of the buckle assembly according to the ninth embodiment of the present disclosure.

FIGS. 33 to 35 show the eighth embodiment of the present disclosure, and FIGS. 36 and 37 show the ninth embodiment of the present disclosure. The eighth embodiment is substantially the same as the second embodiment, and the ninth embodiment is substantially the same as the third embodiment, with the difference therebetween that a finger part 132 may be formed on the first fitting part 130. The specific features of the finger part 132 can be found in the seventh embodiment above.

The buckle assembly of the eighth embodiment integrates an adjusting buckle and a sliding element. Only one sliding element is needed on the belt 30 to realize the length adjustment and height adjustment of the belt.

The buckle assembly of the ninth embodiment has an angle adjustment function, increasing the operability of the user.

A tenth embodiment of the present disclosure will be described below.

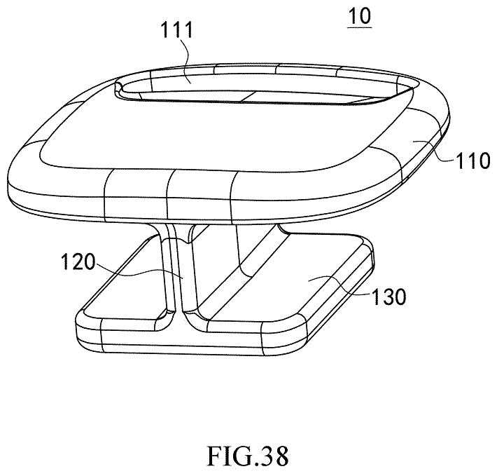

FIG. 38 is a perspective view of the sliding element of the buckle assembly according to a tenth embodiment of the present disclosure.

The tenth embodiment is substantially the same as the seventh embodiment, and the main differences therebetween are as follows.

The first fitting part 130 may be formed as a flat plate perpendicular to the neck. The guiding element 20 may be formed as two hard plates (not shown). The two hard plates may be fixed to a side of the back cushion 90 (as shown in FIGS. 10 and 11) facing the backrest 80 and located at both sides of the slit 910, so that a gap is formed between the two hard plates. That is, the gap between the two hard plates substantially corresponds to the slit 910. The neck 120 may pass through the gap, so that the connecting buckle 110 is located at a side of the guiding element 20 and the first fitting part 130 is located at the other side of the guiding element 20. A size of the neck 120 may be less than the gap and a size of each of the connecting buckle 110 and the first fitting part 130 may be greater than the gap.

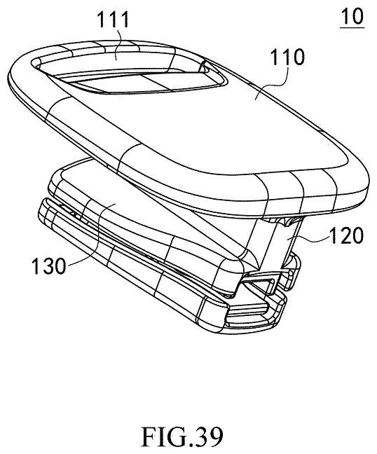

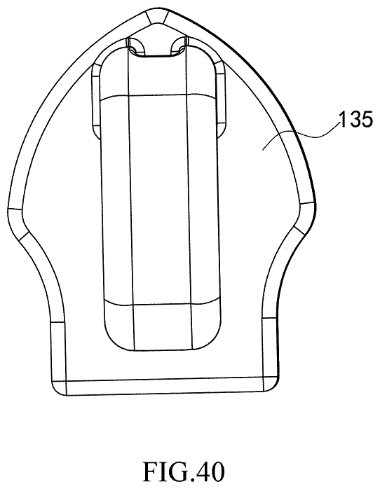

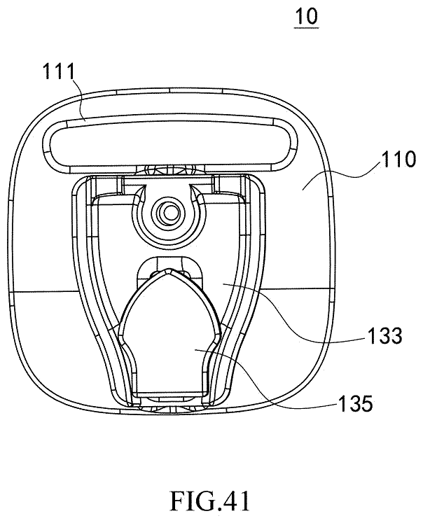

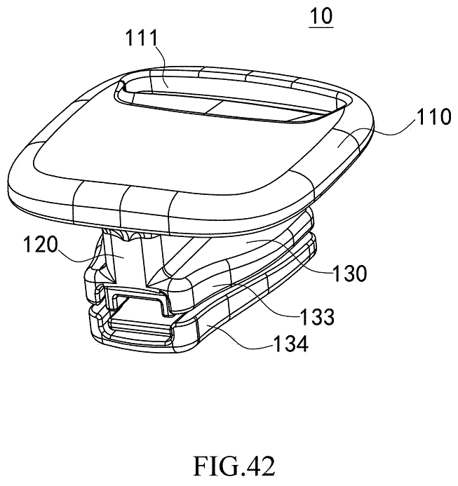

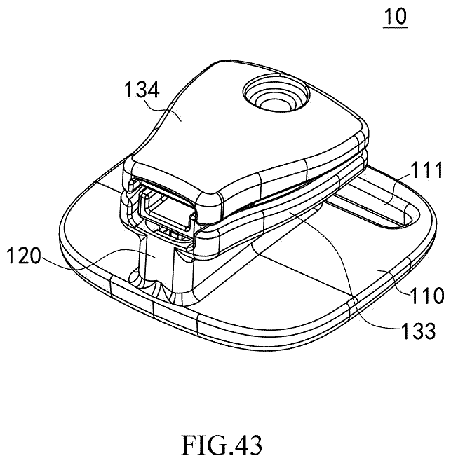

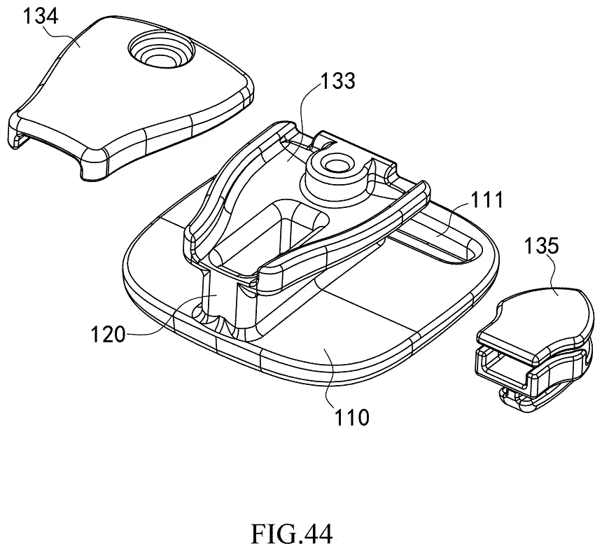

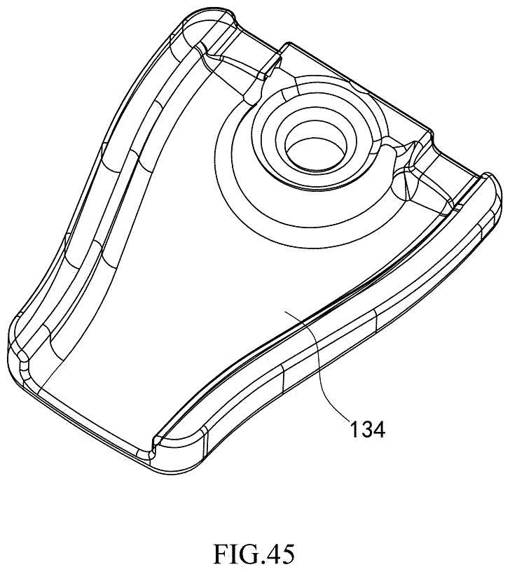

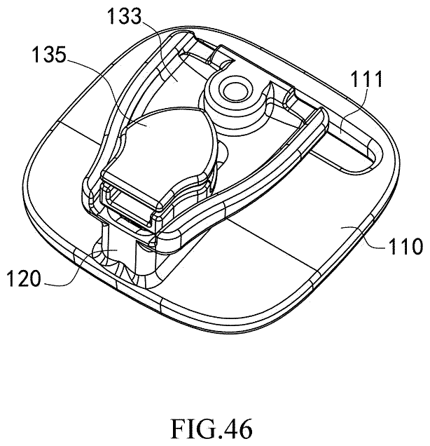

FIG. 39 is a top perspective view of the sliding element of the buckle assembly according to an eleventh embodiment of the present disclosure, FIG. 40 is a plan view of the zipper puller of the buckle assembly according to the eleventh embodiment of the present disclosure, FIG. 41 is a plan view of the sliding element of the buckle assembly according to the eleventh embodiment of the present disclosure, in which a lower buckle is removed, and FIG. 42 is another top perspective view of the sliding element of the buckle assembly according to the eleventh embodiment of the present disclosure, FIG. 43 is a bottom perspective view of the sliding element of the buckle assembly according to the eleventh embodiment of the present disclosure, FIG. 44 is an exploded perspective view of the sliding element of the buckle assembly according to the eleventh embodiment of the present disclosure, FIG. 45 is a perspective view of the lower buckle of the buckle assembly according to the eleventh embodiment of the present disclosure, and FIG. 46 is another bottom perspective view of the sliding element of the buckle assembly according to the eleventh embodiment of the present disclosure in which the lower buckle is removed.

The eleventh embodiment of the present disclosure will be described below.

The eleventh embodiment is substantially the same as the seventh embodiment, and the main differences therebetween are as follows.

Referring to FIGS. 41 and 42, the first fitting part 130 may include an upper buckle 133 and a lower buckle 134. The first fitting part 130 may include a zipper puller 135. The second fitting part 210 may include a zipper (not shown). The zipper may be sewn on the backrest 80. The upper buckle 133 and the lower buckle 134 may surround and fix the zipper puller 135 together. The zipper puller 135 and the zipper may cooperate with each other, so that the sliding element 10 may move on the guiding element 20.

Referring to FIG. 42, the upper buckle 133 may be integrally formed with or fixed to the neck 120. The lower buckle 134 is fixed to the upper buckle 133 by means of screws, for example, but the present disclosure is not limited thereto. A gap may be formed between an outer periphery of the upper buckle 133 and an outer periphery of the lower buckle 134. The zipper may enter a space surrounded by the upper buckle 133 and the lower buckle 134 through the gap, and cooperate with the zipper puller 135.

In this embodiment, the guiding rail is replaced with the zipper, and the sliding element 10 is movably fixed on the backrest 80 via the zipper puller 135 and the zipper, so as to achieve the height adjustment, avoid the uncomfortable problem of the hard guiding rail and improve the comfort of the backrest 80.

In an embodiment, the sliding element comprises a connecting buckle and a neck, and the connecting buckle and the first fitting part are respectively formed at both ends of the neck, the guiding element is formed as two hard plates which are fixed so that a gap is formed between the two hard plates, and the neck passes through the gap, so that the connecting buckle is located on a side of the guiding element and the first fitting part is located on the other side of the guiding element, a size of the neck is less than the gap, and a size of each of the connecting buckle and the first fitting part is greater than the gap.

In an embodiment, the first fitting part comprises one of a zipper puller and a zipper, and the second fitting part comprises the other of the zipper puller and the zipper, and the zipper puller and the zipper are engaged with each other, so that the sliding element is movable on the guiding element.

In an embodiment, the first fitting part comprises the zipper puller, an upper buckle and a lower buckle, and the upper buckle and the lower buckle surround and fix the zipper puller together.

In an embodiment, the sliding element further comprises a connecting buckle and a neck, the neck connects the connecting buckle to the first fitting part, the upper buckle is connected to the neck, the lower buckle is fixed to the upper buckle, and a gap is formed between an outer periphery of the upper buckle and an outer periphery of the lower buckle.

In an embodiment, a sliding element comprises a first fitting part, wherein the first fitting part further comprises a connecting buckle and a neck, the neck connects the connecting buckle to the first fitting part, and a width of the neck is less than a width of either of the connecting buckle and the first fitting part.

In an embodiment, the connecting buckle comprises a through hole for a belt to pass through, the connecting buckle further comprises a locking part, and the locking part is a rod arranged in the through hole for fixing the belt.

In an embodiment, a plurality of protrusions and a plurality of depressions are alternately formed on the locking part.

In an embodiment, the neck is formed with a pivot shaft and the connecting buckle is formed with a pivot hole, and the pivot shaft is positioned in the pivot hole so that the connecting buckle is capable of pivoting with respect to the neck.

In an embodiment, the sliding element comprises two first fitting parts, two necks and a wing, and the guiding element comprises two second fitting parts and two connecting parts, the two first fitting parts are respectively connected to the two second fitting parts, and the wing is connected to the two connecting parts.

Those skilled in the art will easily think of other embodiments of the present disclosure after considering the specification and practicing the invention disclosed herein. The present disclosure is intended to cover any variations, uses or adaptations of the present disclosure, which follow the general principles of the present disclosure and include common knowledge or common technical means in the art that are not disclosed in the present disclosure. The specification and its embodiments are to be regarded as examples only, and the true scope and spirit of the present disclosure are indicated by the claims of the present disclosure.

Although the present disclosure has been described with reference to the typical embodiments as examples, the terminology used is illustrative and exemplary, rather than restrictive. Since the present disclosure can be embodied in various forms without departing from the spirit and essence of the present disclosure, it should be understood that the above-mentioned embodiments are not limited to any of the foregoing details, but should be interpreted in the broadest sense within the scope defined by the claims, and thus all changes that fall within the scope of the claims or their equivalents should be covered by the claims.

1. A buckle assembly, comprising a sliding element and a guiding element,
wherein the sliding element comprises a first fitting part, and the guiding element comprises a second fitting part, and
wherein one of the first fitting part and the second fitting part receives the other, so that the sliding element is connected to the guiding element and the sliding element is slidable linearly on the guiding element.

2. The buckle assembly according to claim 1, wherein the sliding element further comprises a connecting buckle and a neck, the neck connects the connecting buckle to the first fitting part, and a width of the neck is less than a width of either of the connecting buckle and the first fitting part.

3. (canceled)

4. The buckle assembly according to claim 2, wherein the connecting buckle comprises a through hole through which a belt passes, and the connecting buckle further comprises a locking part which is a rod arranged in the through hole for restricting movement of the belt.

5. The buckle assembly according to claim 4, wherein a plurality of protrusions and a plurality of depressions are alternately formed on the locking part.

6. The buckle assembly according to claim 2, wherein the connecting buckle comprises a through hole through which a belt passes, and the buckle assembly further comprises an adjusting buckle, and the adjusting buckle is used to adjust a position where a belt passes through the through hole.

7. (canceled)

8. The buckle assembly according to claim 2, wherein the guiding element further comprises a connecting part, and a width of the connecting part is less than a width of the second fitting part, and one of the first fitting part and the second fitting part is formed as a tubular element, the other of the first fitting part and the second fitting part is formed as an annular element, a side of the annular element away from the neck is formed with an opening, a size of the opening corresponds to a size of the connecting part, and an inner space of the annular element is formed in a cylindrical shape, and the inner space matches with the tubular element.

9. The buckle assembly according to claim 2, wherein the guiding element further comprises a connecting part, and a width of the connecting part is less than a width of the second fitting part, and the guiding element further comprises a wing, the connecting part connects the wing to the second fitting part, and the wing is formed in a flat plate shape.

10. The buckle assembly according to claim 9, wherein the wing is formed on a side of the connecting part opposite to the second fitting part, and the wing is formed as a sheet perpendicular to the connecting part.

11. The buckle assembly according to claim 10, wherein the sliding element comprises two first fitting parts and two necks, and the guiding element comprises two second fitting parts and two connecting parts, wherein the two first fitting parts are connected to the two second fitting parts respectively, and the wings are connected to the two connecting parts.

12. The buckle assembly according to claim 8, wherein the first fitting part is one of an annular element and a tubular element, and the second fitting part is the other of the annular element and the tubular element.

13. The buckle assembly according to claim 10, wherein the annular element is formed with an opening, and the guiding element further comprises a wing formed on both sides of the opening.

14. The buckle assembly according to claim 2, wherein the first fitting part is pivotally connected to the connecting buckle, and/or
wherein the neck is formed with a pivot shaft and the connecting buckle is formed with a pivot hole, and the pivot shaft is positioned in the pivot hole so that the connecting buckle is capable of pivoting with respect to the neck.

15. (canceled)

16. The buckle assembly according to claim 1, wherein the second fitting part is received in the first fitting part, so that the sliding element is connected to the guiding element and is slidable on the guiding element, and
the second fitting part is formed with a plurality of recesses along its length direction, and the first fitting part is formed with a finger part, and each of the recesses is capable of being engaged with the finger part to provide resistance to sliding of the sliding element on the guiding element.

17. The buckle assembly according to claim 13, wherein the plurality of recesses are arranged at a side part of the second fitting part, and the finger part has elasticity in directions close to and away from the second fitting part.

18. The buckle assembly according to claim 16 wherein the first fitting part is formed as a C-shaped clip, the second fitting part is formed as a sliding rail, and the plurality of recesses are arranged on the second fitting part at the same intervals, or
wherein the finger part is pivotable, and the first fitting part further comprises an actuating part which is operated to pivot the finger part in a direction away from the second fitting part.

19. The buckle assembly according to claim 17, wherein the finger part is arranged at a side part of the first fitting part, and an inner side of the finger part is formed with a boss protruding inward, and the boss is capable of forming an interference fit with each of the recesses, or
wherein the finger part is positioned approximately centrally in a length direction of the first fitting part.

20-25. (canceled)

26. A baby carrier comprising:
a frame;
a backrest connected to the frame;
a back cushion having a slit and at least partially covering the backrest;
a belt having an end attached to the frame; and
the buckle assembly according to claim 1, wherein the buckle assembly connects the other end of the belt to the backrest, passes through the slit of the back cushion, and connects the other end of the belt to the backrest to adjust a height of the other end of the belt.

27. The baby carrier according to claim 26, wherein the baby carrier comprises two buckle assemblies and two belts symmetrically located on the backrest.

28. The baby carrier according to claim 27, wherein the buckle assembly comprises a sliding element and a guiding element, the sliding element further comprises a connecting buckle, the connecting buckle is slidably connected to a belt, and the guiding element is arranged on a backrest of the baby carrier.

29. The baby carrier according to claim 28, wherein the baby carrier comprises a back cushion arranged on a side of the backrest, a slit is formed on the back cushion, and the neck of the sliding element passes through the slit, so that the connecting buckle is located at a first side of the back cushion, and the first fitting part is located at a second side of the back cushion opposite to the first side.

30-34. (canceled)
